(19) United States
(12) Patent Application Publication
(10) Pub. No.: US 2008/0036720 A1
(43) Pub. Date: Feb. 14, 2008

(54) System and method for driving a liquid crystal display to reduce audible noise levels

(76) Inventors: Ken K. Foo, Gurnee, IL (US); John W. Kaehler, Lake Bluff, IL (US); Zhiming Zhuang, Kildeer, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/501,982

(22) Filed: Aug. 9, 2006

(51) Int. Cl. G09G 3/36

(52) U.S. Cl. 345/92

(57) ABSTRACT

A system and a method are provided for driving a liquid crystal display (LCD) (30) in manner to reduce audible noise therefrom. A video display system (18) includes a thin film transistor liquid crystal display panel (32) having a plurality of gate electrodes (56), a plurality of source electrodes (58), and a common electrode (62). A common electrode function generator (40) is provided to generate a voltage waveform to drive the common electrode at a plurality of frequencies.

### TECHNICAL FIELD

The present invention generally relates to video display systems, and more particularly relates to a system and method for driving a liquid crystal display (LCD) in a manner to reduce the audible noise emanating therefrom.

### BACKGROUND

In recent years, liquid crystal displays (LCDs) have become widely used in a variety of products such as personal computers, televisions, and wireless communication devices (e.g., cellular phones). One prominent type of LCD is known as a thin film transistor (TFT) LCD. TFT LCDs panels generally include a liquid crystal material filled between two glass plates. The glass plates are typically made of a conductive material or have conductive electrodes formed thereon. The electrodes typically include gate (or row) electrodes and source (or column) electrodes formed on one of the plates and a large common electrode formed on the opposing plate. Voltages applied across the various electrodes cause the liquid crystals to move such that the amount of light that passes through the panel is altered, and as such, images may be formed across the panel.

“Driving schemes” refer to the methods used to modulate the voltages across the various electrodes during the formation of the images. One method, known as “frame inversion,” reverses the polarity of the voltage across both the gate electrodes and the common electrode at the beginning of each frame of operation of the LCD. Another method, referred to as “line inversion,” has become increasingly popular as it provides better video performance than frame inversion. Line inversion alternates the signal polarity of the gate electrodes such that every other row has the same polarity while similarly coordinating modulation of the common electrode.

During line inversion, the frequency at which the common electrode is driven (VCOM) may be expressed as f_{VCOM}=(f_{frame}·n_{row})/2, where f_{frame} is the frame rate and n_{row} is the number of rows in the panel. Often, the frame rate for LCD panels is set at 60 Hertz (Hz), and one common size of LCD panels includes 220 rows. Thus, the frequency at which the common electrode is driven is often between approximately 5 and 7 kHz.

The power consumed by a common electrode may be expressed as

P_{VCOM}=f_{VCOM}·c·V²

where c is the capacitance of the common electrode and V is the peak-to-peak voltage of the common electrode. FIG. 1 graphically illustrates a power distribution for the common electrode (VCOM) being driven with a conventional line driving scheme. As shown, virtually all of the power is consumed at approximately 6 kHz, as the common electrode is driven at a frequency, or frequencies, near 6 kHz.

The driving of the common electrode often causes components of the panel to vibrate at frequency used to drive the common electrode. As such, LCD panels may experience vibrations with frequencies that are approximately 6 kHz, which is within the audible range for humans. Therefore, such vibration often causes the LCD panels to produce unwanted noise during operation.

Accordingly, it is desirable to provide a method for driving a LCD video display which reduces the operation noise of the LCD. Furthermore, other desirable features and characteristics of the present invention will become apparent from the subsequent detailed description and the appended claims, taken in conjunction with the accompanying drawings and the foregoing technical field and background.

### BRIEF SUMMARY

A video display system is provided that includes a thin film transistor liquid crystal display panel having a plurality of gate electrodes, a plurality of source electrodes, a common electrode, and a common electrode function generator coupled to the liquid crystal display panel configured to generate a voltage waveform to drive the common electrode at a plurality of frequencies.

A method is provided that includes providing a thin film transistor liquid crystal display panel having a plurality of gate electrodes, a plurality of source electrodes, and a common electrode. The common electrode is driven at a first frequency during a first portion of a selected one of a plurality of frames of operation of the thin film transistor liquid crystal display and drive at a second frequency during a second portion of the selected one of the plurality of frames of operation of the thin film transistor liquid crystal display panel.

A mobile communications device is provided that includes a housing and a video display subsystem. The video display subsystem includes a thin film transistor liquid crystal display panel coupled to the housing having a plurality of gate electrodes, a plurality of source electrodes, and a common electrode. The subsystem also includes a common electrode function generator coupled to the liquid crystal display panel and configured to generate a voltage waveform to drive the common electrode at a plurality of frequencies, a row sequencer configured to demultiplex the waveform onto the plurality of gate electrodes, and a column address decoder configured to synchronize display information with the row sequencer.

### BRIEF DESCRIPTION OF THE DRAWINGS

The present invention will hereinafter be described in conjunction with the following drawing figures, wherein like numerals denote like elements, and

FIG. 1 is a graph comparing a common electrode driving frequency to a power distribution for a prior art driving scheme;

FIG. 2 is a block diagram of a wireless communication device including a video display system;

FIG. 3 is a block diagram of the video display system of FIG. 2;

FIG. 4 is a cross-sectional isometric view of a thin film transistor (TFT) liquid crystal display (LCD) panel within the video display system of FIG. 3;

FIG. 5 is a temporal view of a first frame of a waveform for driving a common electrode during driving scheme according to one exemplary embodiment;

FIG. 6 is a temporal view of a second frame of the waveform of FIG. 5;

FIG. 7 is a block diagram illustrating a row sequencing process based on the waveform of FIG. 5;

FIG. 8 is a block diagram illustrating a row sequencing process based on the waveform of FIG. 6;

FIG. 9 is a block diagram illustrating the driving scheme of FIGS. 5 and 6; and

FIG. 10 is a graph comparing a common electrode driving frequency to a power distribution for a driving scheme according to one exemplary embodiment.

### DETAILED DESCRIPTION

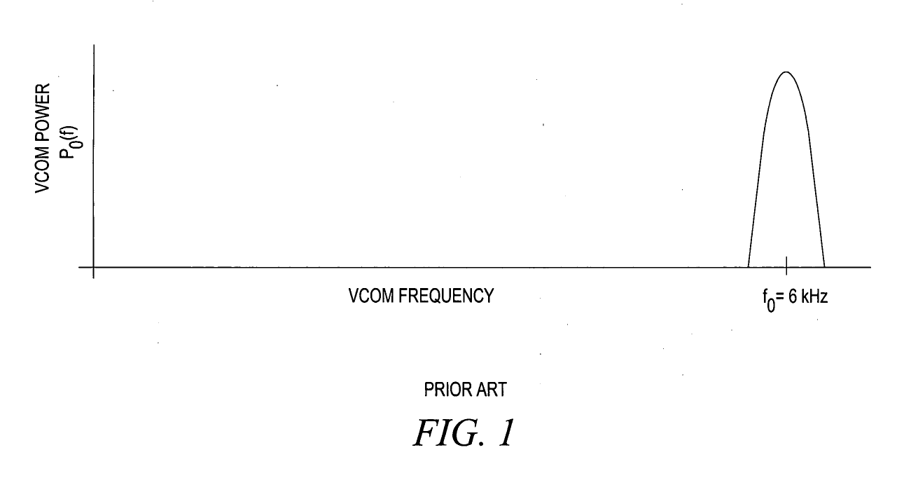

The following detailed description is merely exemplary in nature and is not intended to limit the invention or the application and uses of the invention. Furthermore, there is no intention to be bound by any expressed or implied theory presented in the preceding technical field, background, brief summary or the following detailed description. It should also be noted that FIGS. 1-10 are merely illustrative and may not be drawn to scale.

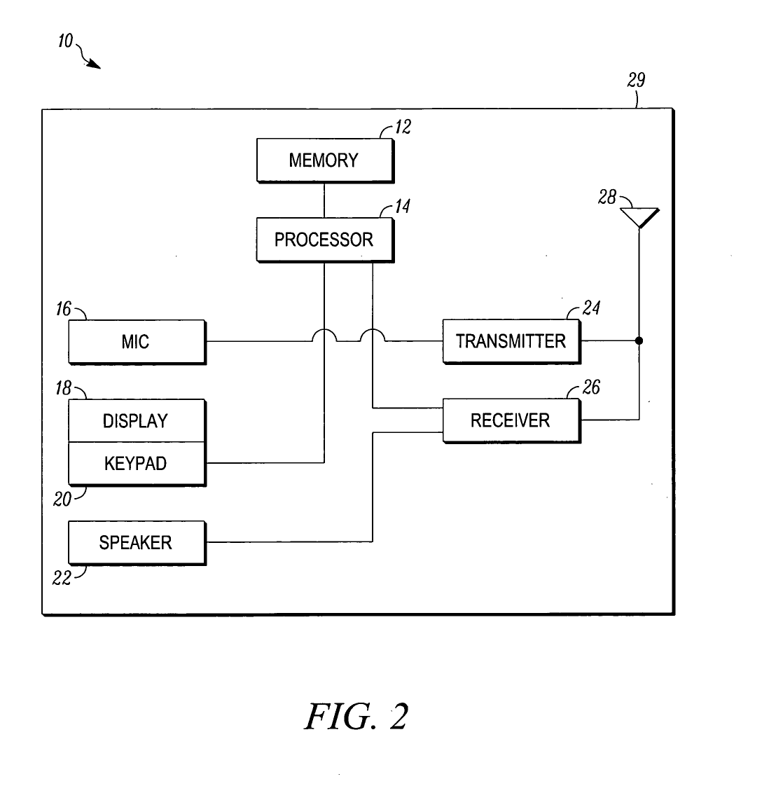

FIG. 2 to FIG. 10 illustrate a method and system for driving a LCD display according to one exemplary embodiment. A video display system includes a thin film transistor liquid crystal display panel having a plurality of gate electrodes, a plurality of source electrodes, and a common electrode. A common electrode function generator is provided to generate a voltage waveform to drive the common electrode at a plurality of frequencies. The voltage waveform includes a plurality of frames, each of which is divided into a plurality of segments. Each segment is associated with a row of gate electrodes in the display panel. During a first of the segments, the common electrode is driven at a first frequency, and during a second of the segments, the common electrode is driven at a second frequency.

FIG. 2 illustrates an exemplary wireless communications device 10. The device 10 includes a memory 12, a processor 14, a microphone 16, a display subsystem 18, a keypad 20, a speaker 22, a transmitter 24, a receiver 26, and an antenna 28. The microphone 16 converts a voice signal to an electrical signal which is transmitted by the transmitter 24 and radiated over the antenna 28. Signals received by the antenna 28 are received and demodulated by the receiver 26 before being converted to an audio signal by the speaker 22. A user inputs information and operates the device 10 using the keypad 20. The display subsystem 18 displays the input, as well as information received by the receiver 26. As is commonly understood, the transmitter 24, the receiver 26, and the antenna 28 may jointly form a radio interface for the telephone 10. The device may be, for example, a cellular communications handset (i.e., cellular telephone), a two-way pager, a wireless communications enabled personal digital assistant, a wireless communications enabled portable, or laptop computer. The device 10 also includes a frame 29 (or housing) to which all of the components shown in FIG. 2 may be connected.

The processor 14 is in operable communication with the memory 12 and controls the telephone 10 by scanning the keypad 20 for inputs, displaying appropriate data on the display 18, and controlling the transmission and reception of the data. Additionally, the processor 14 performs the computation and control functions of the system described below and may comprise any type of processor, include single integrated circuits such as a microprocessor, or may comprise any suitable number of integrated circuit devices and/or circuit boards working in cooperation to accomplish the functions of a processing unit. In addition, processor 14 may comprise multiple processors implemented on separate computer systems, such as a system where a first processor resides on a target computer system designed to closely resemble the final hardware system and a second processor resides on a test computer system coupled to the target hardware system for testing. During operation, the processor 14 executes one or more sets of prestored instructions on the memory 12 and controls the general operation of the display system described below.

The memory 12 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 12 may be a single type of memory component, or it may be composed of many different types of memory components. In addition, the memory 12 and the processor 12 may be distributed across several different computers (e.g., devices).

It should also be understood that while the present invention is described in the context of a fully functioning computer system (e.g. a wireless communications device), those skilled in the art will recognize that the some aspects of the present invention are capable of being distributed as a program product in a variety of forms, and that the present invention applies equally regardless of the particular type of signal bearing media used to carry out the distribution. Examples of signal bearing media include: recordable media such as floppy disks, hard drives, memory cards and optical disks, and transmission media such as digital and analog communication links.

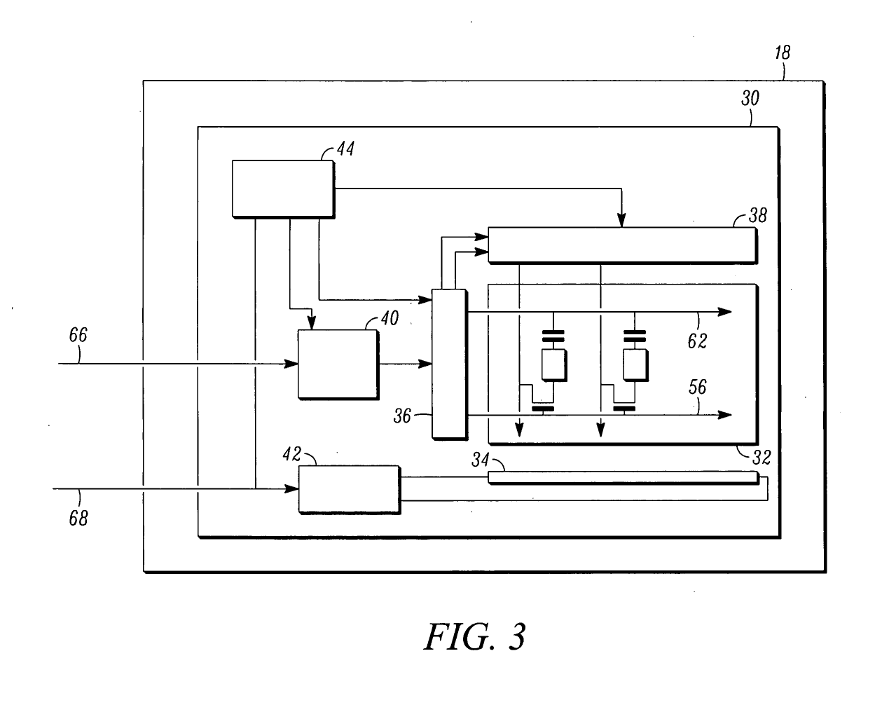

FIG. 3 illustrates the display subsystem 18 in greater detail. The display subsystem 18, in the depicted embodiment, includes a liquid crystal display (LCD) module 30, which may be integral with the frame of the device 10, a LCD panel 32, a backlight 34, a row sequencer 36, a column decoder 38, a controller 40, an inverter 42, and a converter 44.

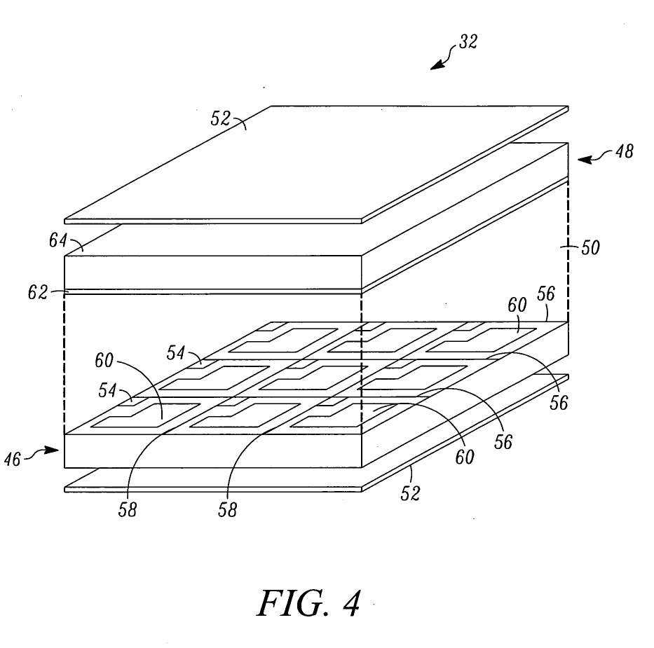

FIG. 4 illustrates a portion of the LCD panel 32 in greater detail. The LCD panel 32 is, in one embodiment, a thin film transistor (TFT) LCD panel and includes a lower substrate 46, an upper substrate 48, a liquid crystal layer 50, and polarizers 52. As will be appreciated by one skilled in the art, the lower substrate 46 may be made of glass and have a plurality of TFT transistors 54 formed thereon, including a plurality of gate electrodes 56 (i.e., row lines), including a plurality of rows of electrodes, and source electrodes 58 (i.e., column lines), including a plurality of columns of electrodes, interconnecting respective rows and columns of the transistors 54. The gate and source electrodes 56 and 58 divide the lower substrate into a plurality of pixels 60, as is commonly understood. The upper substrate 48 may also be made of glass and include a common electrode 62 at a lower portion thereof and a color filter layer 64 at an upper portion thereof. The common electrode may substantially extend across the upper substrate 48. The liquid crystal layer 50 may be positioned between the lower substrate 46 and the upper substrate 48 and include a liquid crystal material suitable for use in a LCD display. As shown, the LCD panel 32 includes two polarizers 52, with one being positioned below the lower substrate 46 and one above the upper substrate 48. Although not illustrated, the polarizers 52 may be oriented such that the respective polarization angles are substantially perpendicular.

Referring again to FIG. 3, the backlight 34 may include a plurality of lamps positioned below the LCD panel 32 and may be, for example, either a direct illumination type backlight or an edge illumination type backlight, as is commonly understood. The remaining circuitry of the display subsystem 18, such as the row decoder 36, the column decoder 38, the controller 40, the inverter 42 (i.e., DC/AC inverter), and the converter 44 (i.e., DC/DC converter), may include various integrated circuits for receiving data signals 66 and power 68 from the remainder of the wireless communications device 10, shown in FIG. 2, and converting the data signals 66 into appropriate images on the LCD panel 32. The row decoder 36 and the column decoder 38 (or column address decoder) may be in the form of integrated circuits electrically connected to the row lines and column lines, respectively, within the LCD panel 32 and configured to drive the row and column lines according to a line driving scheme as described below. The controller 40 may be in operable communications with the row and column decoders 36 and 38, as well as the common electrode 62 shown in FIG. 4, and includes a common electrode function generator to generate a voltage waveform with which to drive the common electrode. Although not specifically illustrate, the controller 40 may include a memory (i.e., a computer-readable medium) on which are stored machine-executable instructions for carrying out the methods and processes described below.

During operation, still referring to FIG. 3, the controller 40 sends control signals to the row decoder 36, the column decoder 38, and the common electrode 62, shown in FIG. 4, to implement a driving scheme to modulate the voltages across the gate electrodes 56, source electrodes 58, and the common electrode 62 to spread the driving of the common electrode 62 across multiple frequencies.

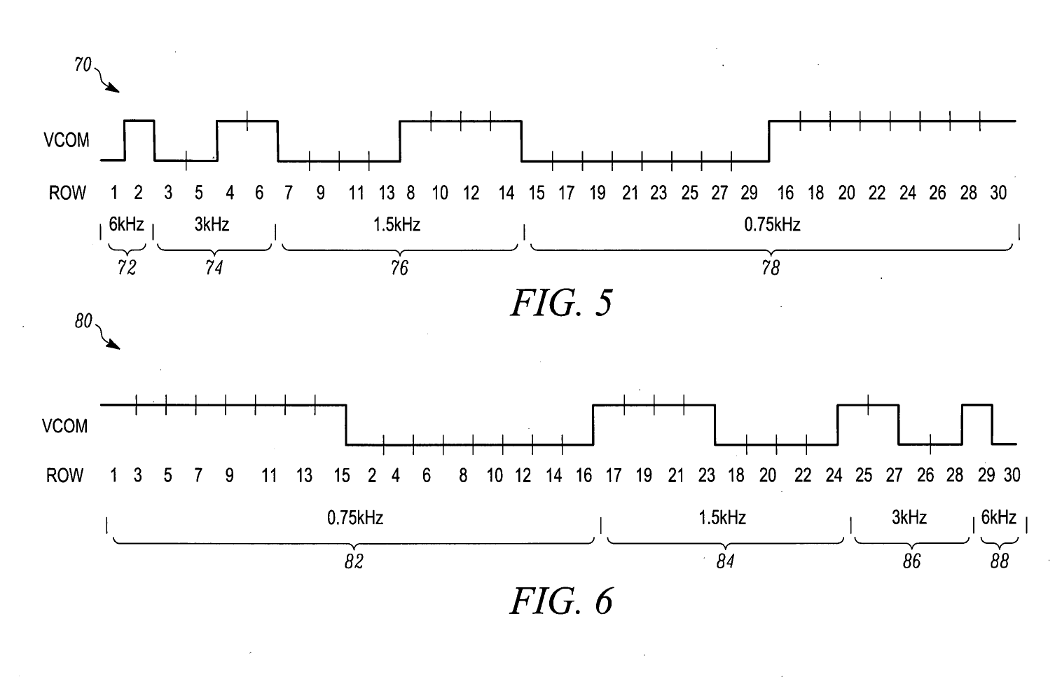

FIGS. 5 and 6 illustrate waveforms (or portions of a waveform) for driving or modulating the common electrode 62 (VCOM) and the gate electrodes 56 (Row) during two frames, respectively, of a driving scheme according to one embodiment of the present invention. Referring specifically to FIG. 5, a first frame 70 includes a first portion 72, a second portion 74, a third portion 76, and a fourth portion 78. During the first portion 72, which includes segments 1 and 2, which are, as described below, associated with the modulations of rows 1 and 2, the common electrode is modulated at a frequency (hereinafter “common electrode frequency”) of 6 kHz, with a negative polarity being applied during segment 1 and a positive polarity being applied during segment 2. During the second portion 74, which includes segments 3, 5, 4, and 6 (i.e., row modulations 3, 5, 4, and 6), the common electrode frequency is 3 kHz. As shown, a negative polarity is applied to the common electrode during segments 3 and 5, and a positive polarity is applied during segments 4 and 6. During the third portion 76 (i.e., segments 7, 9, 11, 13, 8, 10, 12, and 14), the common electrode frequency is 1.5 kHz, and during the fourth portion 78 (segments 15-30, as ordered in FIG. 5), the common electrode frequency is 0.75 kHz. As in the first and second portions 72 and 74, the common electrode polarity changes from negative to positive after half the segments have occurred in the third and fourth portions 76 and 78 of the first frame 70.

Thus, the progression of the portions 72-78 in the first frame 70 is such that from one portion to the next, the common electrode frequency is reduced by 50% and the number of segments (i.e., row modulations) in which that frequency is used is doubled.

FIG. 6 illustrates a second frame 80, which may follow the first frame 70 shown in FIG. 5, in a driving scheme in accordance with the exemplary embodiment. As shown, the second frame 80 also includes a first portion 82, a second portion 84, a third portion 86, and a fourth portion 88. However, in the second frame 80, from one portion to the next, the common electrode frequency is doubled and the number of segments over which that particular frequency is used is reduced by 50%. Additionally, contrary to the modulation within the first frame 70, during the second frame 80, the common electrode polarity switches from positive to negative after half of the segments within each portion have occurred.

Although the first frame 70 and the second frame 80 are shown and described as including only 30 segments (i.e., row modulations), it should be understood that the frames may, for example, include a much greater number of segments (i.e., one segment for each row line or gate electrode within the LCD panel), such as 220, and the example shown has been simplified for illustrative purposes. Additionally, it should be understood that the common electrode frequencies shown (i.e., 6 kHz, 3 kHz, 1.5 kHz, and 0.75 kHz) correspond to the common electrode frequencies that would be used for an LCD display having 220 rows.

Furthermore, it should be noted that in both the first and second frames 70 and 80, the rows are not driven in sequential (i.e., numeric) order. As will be appreciated by one skilled in the art, the order in which the rows (i.e., gate electrodes) are driven as shown in FIGS. 5 and 6 may be implemented to prevent any of the rows, or pixels, from retaining a net voltage after multiple frames. That is, the exemplary driving scheme illustrated in FIGS. 5 and 6 drives the rows such that over the course of multiple frames, opposing polarities (i.e., positive and negative) are applied to each row for substantially equal amounts of time.

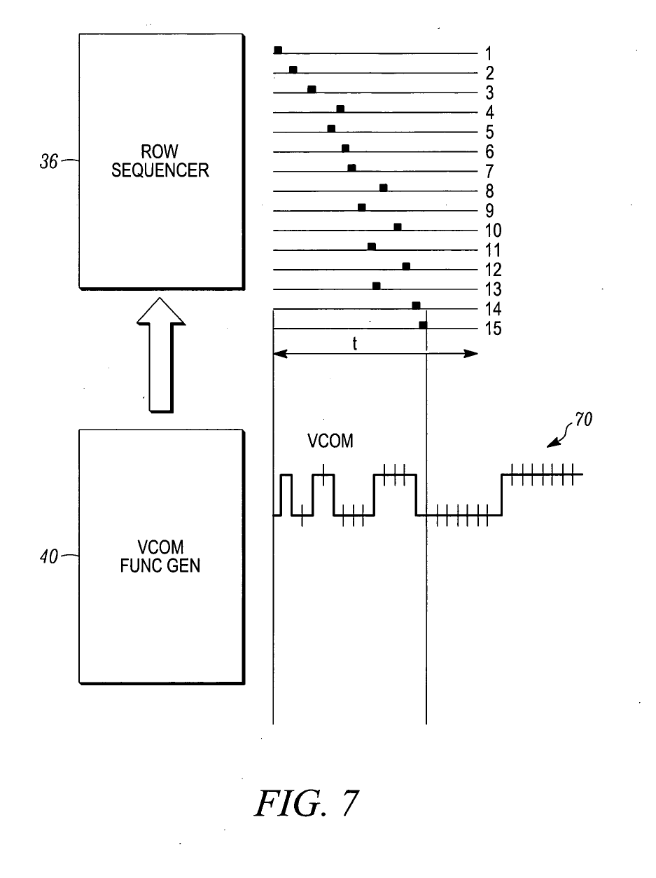

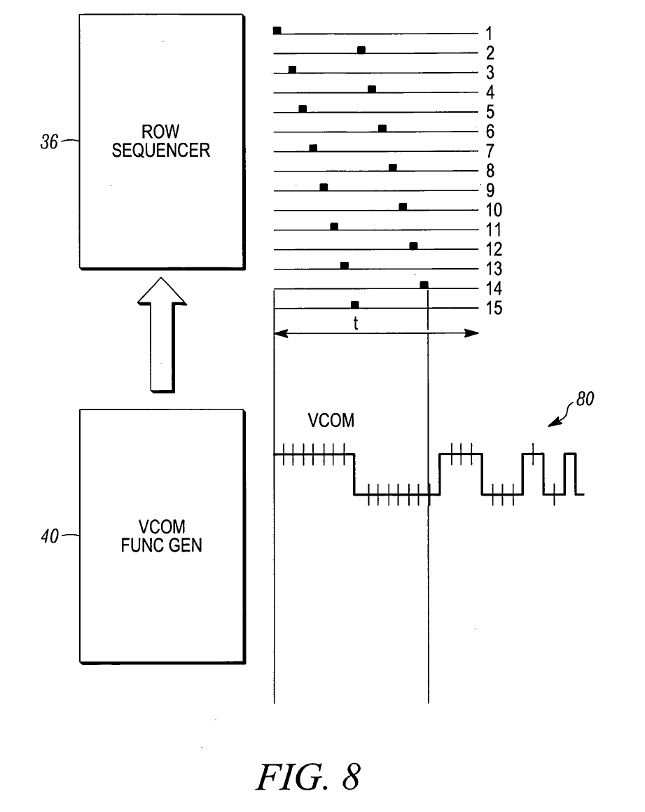

FIGS. 7 and 8 illustrate a modulation scheme for the rows, as implemented by the row sequencer 36 in FIG. 3 simultaneously with the modulation of the common electrode as described above. In one embodiment, the row sequencer 36 is configured (i.e., preprogrammed) to demultiplex the waveform shown in FIGS. 5 and 6 and modulate the rows in the same order in which the rows (i.e., segments) are listed in FIGS. 5 and 6. The modulation of each row is thus association with the segments shown in FIGS. 5 and 6. Thus, in FIG. 7, which illustrates the row sequencing during the first frame 70, the rows are modulated in the following order: 1, 2, 3, 5, 4, 6, 7, 9, 11, 13, 8, 10, 12, 14, 15. Likewise, in FIG. 8, which illustrates the row sequencing during the second frame 80, the rows shown are modulated in the following order: 1, 3, 5, 7, 9, 11, 13, 15, 2, 4, 6, 8, 10, 12, 14. Although only a portion of the rows within each frame are shown in FIGS. 7 and 8, it should be understood that the row sequencing for each of the remainder of the frames 70 and 80 matches the order of the row modulation shown in FIGS. 5 and 6.

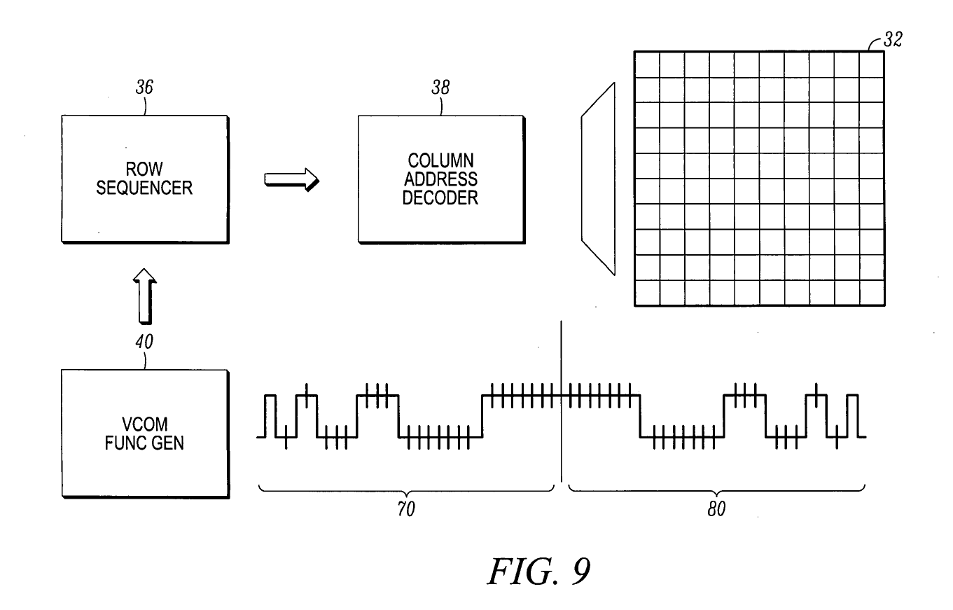

As illustrated in FIG. 9, the first and second frames 70 and 80 are also received by the column address decoder 38, which synchronizes display information with the row sequencer 36. Also referring now to FIG. 3, the controller 40, the row decoder 36, and the column address decoder 38 thus provide driving signals to the gate, source, and common electrodes 55, 58, and 62 within the LCD panel 32. As is commonly understood, the voltage applied across each pixel 60 dictates the amount of movement, or twisting, exhibited by the liquid crystals thereabove to control the amount of light (from the backlight 34) which passes through the LCD panel 32.

One advantage of the video display system described above is that the amount of audible noise created is reduced, while still maintaining optimal video performance. As described above, the frequency at which the common electrode is modulated during line inversion driving, may be expressed as f_{VCOM}=(f_{frame}×n_{row})/2. Thus, the power consumed by the common electrode may be expressed as

P_{VCOM}=f_{VCOM}·c·V²

where c is the capacitance of the common electrode and V is the peak-to-peak voltage of the common electrode. Therefore, the total energy (i.e., power multiplied by time) used by the common electrode may be expressed as

E_{VCOM}=f_{VCOM}·c·V²·T

where T is the time driven at the particular frequency. If multiple frequencies are used, the energy becomes

E_{VCOM}=(f₁·T₁+f₂·T₂+f₃·T₃+ . . . +fₙ·Tₙ)c·V²

where n is the total number of frequencies.

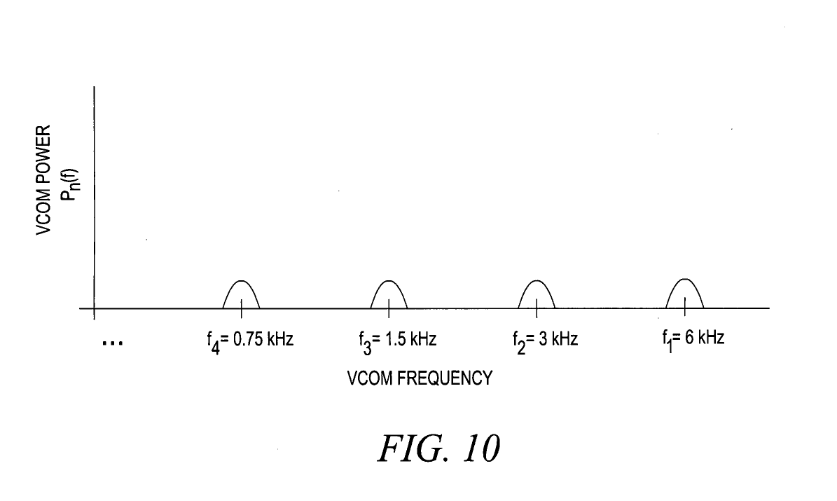

Therefore, if the time is increased as the frequency is decreased, the total energy used by the common electrode remains constant. In the driving scheme described above, the energy and/or power used by the common electrode is spread across multiple frequencies, as illustrated in FIG. 10, such that the power and/or energy used by the common electrode at frequencies that correspond to the audible range for humans is reduced. As a result, the audible noise that occurs from the common electrode being driven is minimized.

Other embodiments may utilize LCD panels with different number of rows and columns. For example, the number of rows may be between, for example, 100 and 800. Additionally, as will be appreciated by one skilled in the art, the system and method described above may be applied to common electrode frequencies up to approximately 20 kHz (i.e., corresponding to the highest frequency at which humans can hear). Furthermore, the common electrode frequency, as well as the number of segments in each portion of the frames, may change from portion to portion at a rate different than that described above. For example, between consecutive portions, the common electrode frequency may increase or decrease by, for example, between 10 and 90%. The order which the rows are modulated may also be changed, as the embodiments described above are merely examples of many possible waveforms and row modulation schemes in accordance with the present invention.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A video display system comprising:
a thin film transistor liquid crystal display panel having a plurality of gate electrodes, a plurality of source electrodes, and a common electrode; and
a common electrode function generator coupled to the liquid crystal display panel configured to generate a voltage waveform to drive the common electrode at a plurality of frequencies.

2. The video display system of claim 1, wherein the plurality of gate electrodes comprises a plurality of rows of electrodes and the waveform generated by the common electrode function generator comprises a plurality of frames, each frame comprising a plurality of row segments, each row segment being associated with a selected one of the plurality of rows of electrodes.

3. The video display system of claim 2, wherein the waveform generated by the common electrode function generator drives the common electrode at a first frequency during a first row segment of the waveform and drives the common electrode at a second frequency during a second row segment of the waveform.

4. The video display system of claim 3, wherein the first row segment and the second row segment are within a selected one of the plurality of frames of the waveform and the second row segment occurs after the first row segment.

5. The video display system of claim 4, wherein each of the plurality of frames comprises a first number of the first row segments and a second number of the second row segments.

6. The video display system of claim 5, wherein the first frequency is greater than the second frequency if the first number of the first row segments is less than the second number of the second row segments, and the second frequency is greater than the first frequency if the second number of the second row segments is less than the first number of the first row segments.

7. The video display system of claim 6, wherein within a first of the plurality of frames, the first number of the first row segments is less than the second number of the second row segments and the first frequency is greater than the second frequency, and within a second of the plurality of frames, the second number of the second row segments is less than the first number of the first row segments and the second frequency is greater than the first frequency.

8. The video display system of claim 7, wherein each of the plurality of frames further comprises a third number of third row segments, the waveform generated by the common electrode function generator drives the common electrode at a third frequency during the third row segments, the third frequency is greater than each of the first and second frequencies if the third number of third row segments is less than each of the first number of the first row segments and the second number of the second row segments, and each of the first and second frequencies is greater than the third frequency if each of the first number of the first row segments and the second number of the second row segments is less than the third number of third row segments.

9. The video display system of claim 3, wherein the plurality of gate electrodes comprise between 100 and 800 rows of electrodes, and the first and third frequencies are not greater than 20 kHz.

10. The video display system of claim 2, further comprising:
a row sequencer configured to demultiplex the waveform onto the plurality of rows of electrodes; and
a column address decoder configured to synchronize display information with the row sequencer.

11. A method comprising:
providing a thin film transistor liquid crystal display panel having a plurality of gate electrodes, a plurality of source electrodes, and a common electrode; and
driving the common electrode at a first frequency during a first portion of a selected one of a plurality of frames of operation of the thin film transistor liquid crystal display and driving the common electrode at a second frequency during a second portion of the selected one of the plurality of frames of operation of the thin film transistor liquid crystal display panel.

12. The method of claim 11, wherein said driving of the common electrode at the second frequency occurs after said driving of the common electrode at the first frequency.

13. The method of claim 12, wherein each of the plurality of frames comprises a first number of first row segments associated with a first of the plurality of gate electrodes and a second number of second row segments associated with a second of the plurality of gate electrodes and further comprising driving the first of the plurality of gate electrodes during said driving of the common electrode at the first frequency and driving the second of the plurality of gate electrodes during said driving of the common electrode at the second frequency.

14. The method of claim 13, wherein the first frequency is greater than the second frequency if the first number of the first row segments is less than the second number of the second row segments, and the second frequency is greater than the first frequency if the second number of the second row segments is less than the first number of the first row segments.

15. A mobile communications device comprising:
a housing; and
a video display subsystem comprising:
a thin film transistor liquid crystal display panel coupled to the housing having a plurality of gate electrodes, a plurality of source electrodes, and a common electrode;
a common electrode function generator coupled to the liquid crystal display panel configured to generate a voltage waveform to drive the common electrode at a plurality of frequencies;
a row sequencer configured to demultiplex the waveform onto the plurality of gate electrodes; and
a column address decoder configured to synchronize display information with the row sequencer.

16. The mobile communications device of claim 15, wherein the waveform generated by the common electrode function generator comprises a plurality of frames, each frame comprising a first number of first row segments and a second number of second row segments, each row segment being associated with a selected one of the plurality of gate electrodes.

17. The mobile communications device of claim 16, wherein the common electrode function generator drives the common electrode at a first frequency during the first number of first row segments and drives the common electrode at a second frequency during the second number of second row segments.

18. The mobile communications device of claim 17, wherein the first frequency is greater than the second frequency if the first number of the first row segments is less than the second number of the second row segments, and the second frequency is greater than the first frequency if the second number of the second row segments is less than the first number of the first row segments.

19. The mobile communications device of claim 18, wherein each of the plurality of frames further comprises a third number of third row segments, the waveform generated by the common electrode function generator drives the common electrode at a third frequency during the third row segments, the third frequency is greater than each of the first and second frequencies if the third number of third row segments is less than each of the first number of the first row segments and the second number of the second row segments, and each of the first and second frequencies is greater than the third frequency if each of the first number of the first row segments and the second number of the second row segments is less than the third number of third row segments.

20. The mobile communications device of claim 19, wherein the plurality of gate electrodes comprise between 100 and 800 rows of electrodes, and the first, second, and third frequencies are not greater than 20 kHz.
